(19) United States
(12) Patent Application Publication
(10) Pub. No.: US 2015/0036128 A1
(43) Pub. Date: Feb. 5, 2015

(54) INSPECTION APPARATUS

(71) Applicant: Genesis Photonics Inc., Tainan City (TW)

(72) Inventors: Cheng-Pin Chen, Tainan City (TW); Gwo-Jiun Sheu, Tainan City (TW); Yun-Li Li, Taipei City (TW)

(21) Appl. No.: 14/311,362

(22) Filed: Jun. 23, 2014

(30) Foreign Application Priority Data
Jul. 31, 2013 (TW) 102127521

(51) Int. Cl. G01N 21/01; G01N 21/95

(52) U.S. Cl. CPC G01N 21/01; G01N 21/9501
USPC 356/237.5

(57) ABSTRACT

An inspection apparatus is capable of inspecting a light-emitting diode (LED). The inspection apparatus includes a reflecting cover, a base plate, a light-collecting unit and at least one inspection light source. An enclosed space is defined by the base plate and the reflecting cover having an opening. The LED is disposed on the base plate and located in the enclosed space. The light-collecting unit is disposed above the LED and in the enclosed space. A vertical distance from the light-collecting unit to the LED is H, a width of the opening of the reflecting cover is W, and H/W=0.05 to 10. The inspection light source is in the enclosed space. An inspection light emitted from the inspection light source is reflected by the reflecting cover and then emitted into the LED.

A dominant wavelength of the inspection light source is smaller than that of the LED.

### CROSS-REFERENCE TO RELATED APPLICATION

This application claims the priority benefit of Taiwan application serial no. 102127521, filed on Jul. 31, 2013. The entirety of the above-mentioned patent application is hereby incorporated by reference herein and made a part of this specification.

### BACKGROUND OF THE INVENTION

1. Field of the Invention

The invention relates to an inspection apparatus, and particularly relates to an inspection apparatus for inspecting a light source.

2. Description of Related Art

The manufacturing process of light-emitting diodes includes several testing steps, such as the luminance test, to test whether the performance of the products meets the basic factory specification, so as to ensure the quality of the light-emitting diodes leaving the factory. One of the inspection apparatuses has an inspection light source having a dominant wavelength smaller than the dominant wavelength of the light-emitting diodes. This kind of inspection apparatus tests optical data, such as luminance, of the light-emitting diodes by photoexciting the light-emitting diodes using the inspection light source. However, since only part of the inspection light emitted by the inspection light source may be emitted into the light-emitting diodes, some of the light-emitting diodes may not be excited to emit light or only emit light at a weaker luminance after being excited due to insufficient energy of the light received, making it difficult to distinguish between non-defective and defective products. It is thus difficult to facilitate the inspection efficiency, and may even result in loss due to misjudgment.

### SUMMARY OF THE INVENTION

The invention provides an inspection apparatus capable of improving a proportion of light emitted from an inspection light source to a light-emitting diode, thus facilitating inspection efficiency.

An inspection apparatus of the invention is capable of inspecting a light-emitting diode. The inspection apparatus includes a reflecting cover, a base plate, a light-collecting unit, and at least one inspection light source. The reflecting cover has an opening. The base plate contacts the opening of the reflecting cover and defines an enclosed space with the reflecting cover. In addition, the light-emitting diode is disposed on the base plate and located in the enclosed space. The light-collecting unit is disposed above the light-emitting diode and at least partially located in the enclosed space. In addition, a vertical distance from the light-collecting unit to the light-emitting diode is H, a width of the opening of the reflecting cover is W, and H/W=0.05 to 10. The inspection light source is located in the enclosed space. An inspection light emitted from the inspection light source is reflected by the reflecting cover and then emitted into the LED, and a dominant wavelength of the inspection light is smaller than a dominant wavelength of the light-emitting diode.

According to an embodiment of the invention, a shape of a vertical profile of the reflecting cover is an arc shape.

According to an embodiment of the invention, a shape of a vertical profile of the reflecting cover is an inverted V shape, an inverted U shape, or a polygonal shape.

According to an embodiment of the invention, the number of the at least one inspection light source is two, the light-emitting diode has a central line dividing the light-emitting diode into two blocks, and the inspection light sources are located at two sides of the central line.

According to an embodiment of the invention, the at least one inspection light source is disposed on the base plate and adhered to the base plate.

According to an embodiment of the invention, the reflecting cover has a symmetrical paraboloid structure and has two focal points, and the inspection light sources are respectively located on the focal points of the reflecting cover.

According to an embodiment of the invention, an irradiation area of the inspection light on the base plate after being reflected by the reflecting cover is larger than an area of an orthogonal projection of the light-emitting diode on the base plate, and the orthogonal projection of the light-emitting diode on the base plate is located in an irradiation region of the inspection light on the base plate after being reflected by the reflecting cover.

According to an embodiment of the invention, the reflecting cover has a gap, and the light-collecting unit is embedded into the gap.

According to an embodiment of the invention, the light-collecting unit includes a charge coupled device, an integral sphere, a solar panel, or a photodetector array.

According to an embodiment of the invention, a reflection rate of the reflecting cover is over 85%.

According to an embodiment of the invention, a difference between the dominant wavelength of the inspection light source and the dominant wavelength of the light-emitting diode is at least greater than or equal to 20 nanometers.

According to an embodiment of the invention, the dominant wavelength of the inspection light source ranges between 320 nanometers and 400 nanometers.

Based on the above, the inspection apparatus of the invention utilizes a non-destructive way to obtain the optical data of the light-emitting diode, so there is no damage done to the light-emitting diode. The reliability of products is thus improved. Furthermore, the light-emitting diode and the inspection light source of the inspection apparatus of the invention are located in the enclosed space formed by the base plate and the reflecting cover. The inspection light may be reflected to the light-emitting diode by the reflecting cover. With the configuration, the inspection apparatus may allow most of the inspection light emitted by the inspection light source to be emitted into the light-emitting diode, so as to increase a utilization rate of the detection light sources. In addition, with the configuration that the ratio between the distance from the light-collecting unit to the light-emitting diode and the width of the opening of the reflecting cover ranges between 0.05 and 10, more of the inspection light may be reflected to the light-emitting diode, and the light-collecting unit may collect more of the optical data emitted from the light-emitting diode.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic view of an inspection apparatus according to an embodiment of the invention.

FIGS. 1B, 1C, and 1D are schematic views of reflecting covers in other shapes according to an embodiment of the invention.

FIG. 2 is a schematic view of an inspection apparatus according to another embodiment of the invention.

### DESCRIPTION OF THE EMBODIMENTS

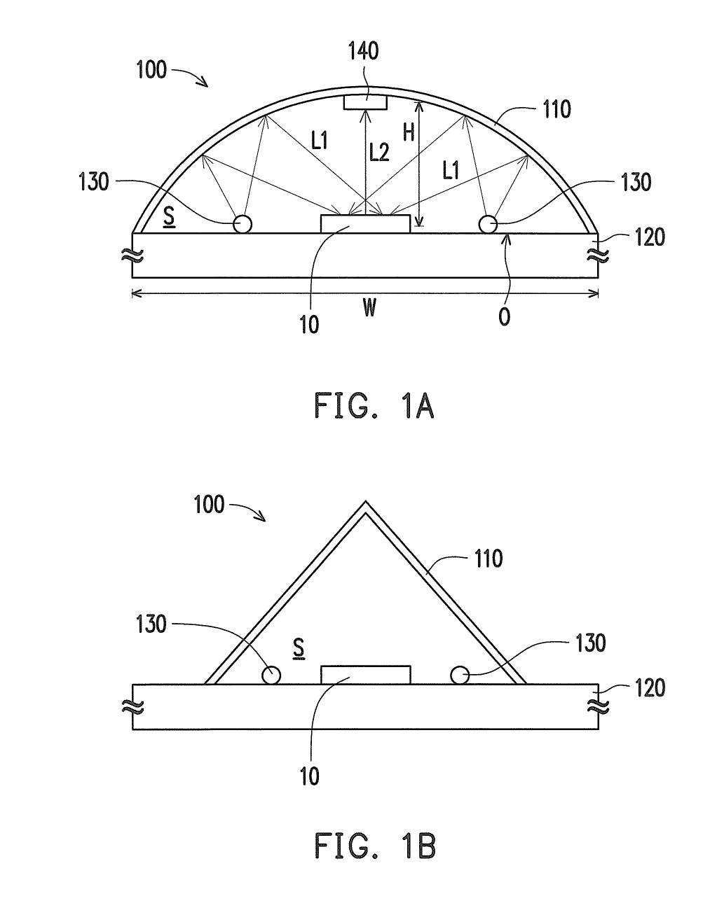

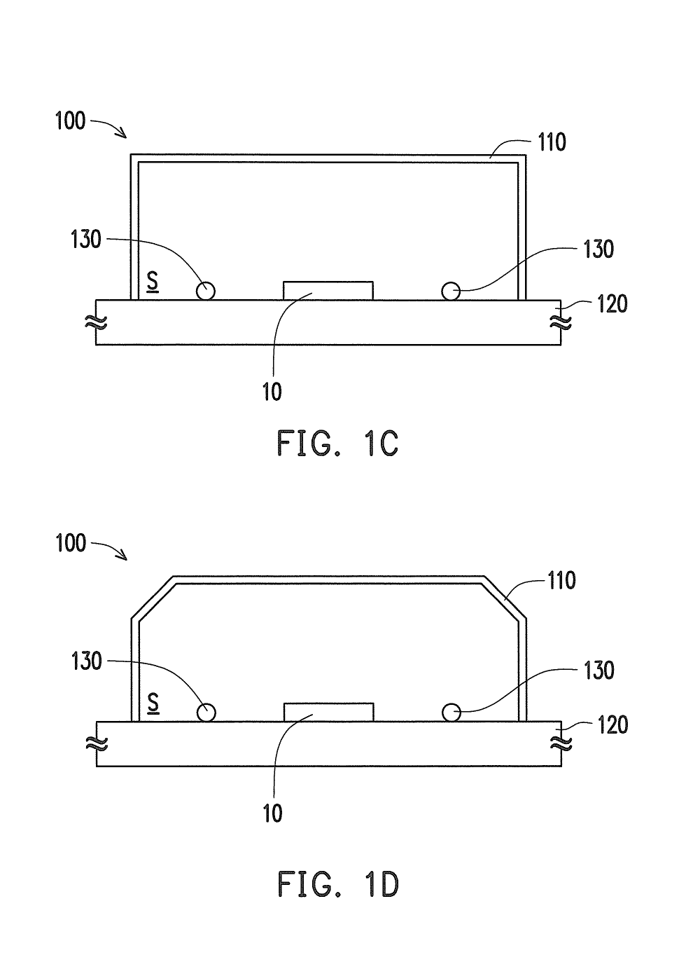

FIG. 1A is a schematic view of an inspection apparatus according to an embodiment of the invention. Referring to FIG. 1A, an inspection apparatus 100 of this embodiment is capable of inspecting a light-emitting diode 10. The inspection apparatus 100 includes a reflecting cover 110, a base plate 120, at least one inspection light source 130 and a light-collecting unit 140.

The reflecting cover 110 has an opening O, the base plate 120 contacts the opening O of the reflecting cover 110 and defines an enclosed space S. Herein, the light-emitting diode 10 is disposed on the base plate 120 and located in the enclosed space S. In this embodiment, the light-emitting diode 10 is a light-emitting diode chip, for example. However, in other embodiments that are not shown herein, the light-emitting diode 10 may also be a wafer. Also, the wafer may include a plurality of light-emitting diode chips, and the inspection apparatus 100 may simultaneously inspect the plurality of light-emitting chips on the wafer.

In this embodiment, the number of the inspection light source 130 is realized as two. However, in other embodiments that are not shown herein, there may be only one or more than two of the inspection light sources 130. The user may make an adjustment in this respect based on the needs, and the invention is not limited thereto. The two inspection light sources 130 of this embodiment are respectively located in the enclosed space S, and the light-emitting diode 10 is disposed at a central position of the base plate 120. The light-emitting diode 10 has a central line that divides the light-emitting diode 10 into two blocks. The inspection light sources 130 are respectively located at two sides of the central line, such that a light-emitting diode located at the periphery may receive a stronger luminous flux and the light-emitting diode 10 may be effectively excited to emit light. The two inspection light sources 130 and the light-emitting diode 10 are located on proximate horizontal surfaces. Specifically speaking, in this embodiment, the two inspection light sources 130 are located on the base plate 120 and adhered to the base plate 120. Since a surface of the base plate 120 may not be completely flat in the actual practice, different positions on the base plate 120 may be slightly different in height. If the factor that the base plate 120 may not be manufactured to be completely flat is ignored, the inspection light sources 130 and the light-emitting diode 10 are actually located on the same horizontal surface. Such configuration not only brings the ease of configuration but needs no additional component installed to support the inspection light sources 130. In addition, when an inspection light L1 is emitted into the light-emitting diode 10 after being reflected by the reflecting cover 110, the circumstance that part of the light is unable to be emitted into the light-emitting diode 10 due to blockage of the detection light sources 130 does not occur. In this embodiment, a reflection rate of the reflecting cover 110 may be over 85%, such that most of the inspection light L1 emitted by the inspection light sources 130 is emitted into the light-emitting diode 10 after being reflected by the reflecting cover 110. Preferably, the reflecting cover 110 may be coated with a barium sulphate layer to provide a more preferable effect of reflection. When an irradiation area of the inspection light L1 on the base plate 120 after being reflected by the reflecting cover 110 is larger than an area of an orthogonal projection of the light-emitting diode 10 on the base plate 120, and the orthogonal projection of the light-emitting diode 10 on the base plate 120 is in an irradiation region of the inspection light L1 on the base plate 120 after being reflected by the reflecting cover 110, namely when the light-emitting diode 10 fully receives light, a chance that the light-emitting diode 10 is excited may increase, and an accuracy of inspection may thus be facilitated.

In this embodiment, a shape of a vertical profile of the reflecting cover 110 is realized as an arc shape. However, in other embodiments, the shape of the vertical profile of the reflecting cover 110 may be designed as an inverted V shape, an inverted U shape, or a polygonal shape based on the inspection needs or the working environment. For example, in FIG. 1B, the shape of the vertical profile of the reflecting cover 110 is the inverted V shape; in FIG. 1C, the shape of the vertical profile of the reflecting cover 110 is the inverted U shape; and in FIG. 1D, the shape of the vertical profile of the reflecting cover 110 is the polygonal shape. Therefore, a three-dimensional shape of the reflecting cover 110 may be a shape of hemisphere, ellipsoid, cone, pyramid, cylinder, or prism, etc., as long as the reflecting cover 110 forms the enclosed space S with the base plate 120 and reflects the inspection light L1 emitted by the inspection light sources 130 to the light-emitting diode 10. Therefore, the shape of the reflecting cover 110 described herein only serves as an illustrative purpose, and the invention is not limited thereto. It should be noted that due to the curvature of the surface of the reflecting cover 110, when the shape of the vertical profile of the reflecting cover 110 is the arc shape, there is a preferable light-collecting effect for the inspection light L1 emitted into the arc-shaped reflecting cover 110, which may increase a luminous flux of the inspection light L1 emitted into the light-emitting diode 10 after being reflected by the arc-shaped reflecting cover 110.

The inspection apparatus 100 of this embodiment photoexcites the light-emitting diode 10 by the inspection light L1, such that the light-emitting diode 10 emits an excited light L2, and an optical data of the light-emitting diode 10 is obtained accordingly. Therefore, a dominant wavelength of the inspection light L1 of the inspection light source 130 is smaller than a dominant wavelength of the light-emitting diode 10. Taking the light-emitting diode 10 as a blue light-emitting diode for example, the dominant wavelength of the inspection light L1 of the inspection light source 130 ranges between 320 and 400 nanometers, and the dominant wavelength of the light-emitting diode 10 is about 450 nanometers. However, the dominant wavelengths of the inspection light source 130 and the light-emitting diode 10 are not limited thereto, as long as a difference between the dominant wavelengths of the inspection light source 130 and the light-emitting diode 10 is at least more than or equal to 20 nanometers. When the difference becomes greater, the energy of the inspection light L1 is also greater, making it easier to excite the light-emitting diode 10 to emit light. In this embodiment, the optical data of the light-emitting diode 10 is a light intensity data or a luminous flux data, etc.

It should be noted that the inspection principle of the present application is that, generally speaking, when an epitaxial layer of the light-emitting diode 10 receives an emitted light having energy greater than an energy level of the material, electrons in a stable sate may be transited to an excited state. When the electrons return to the stable state from the excited state, the energy is released in the Ram of light, namely photoluminescence. However, if there is a parallel circuit generated or the epitaxial layer is defective, some of the electrons may not be able to return to the stable state. At this time, the luminous flux or light intensity generated may decrease. Therefore, the user may determine the light-emitting diode 10 that does not meet the standard by observing variation of the optical data.

The light-collecting unit 140 is disposed above the light-emitting diode 10 and at least partially located in the enclosed space S. In this embodiment, the whole light-collecting unit 140 is located in the enclosed space S and fixed on the reflecting cover 110. The light-collecting unit 140 is configured to collect the optical data of the light-emitting diode 10. In addition, the light-collecting unit 140 may be a charge coupled device, an integral sphere, a solar panel, or a photodetector array, etc. The light-collecting unit 140 may be electrically connected to an electronic computing apparatus (not shown), so as to compare the collected optical data with a standard data of the light-emitting diode 10. Accordingly, the light-emitting diode 10 that does not meet the standard may be determined. Therefore, whether the light-emitting diode 10 meets the standard maybe accurately determined, and the inspection apparatus 100 of this embodiment thus has a preferable inspection efficiency and accuracy.

As shown in FIG. 1A, a vertical distance from the light-collecting unit 140 to the light emitting diode 10 is H, and a width of the opening O of the reflecting cover 110 is W. Preferably, a ratio of H/W=0.05 to 10. By utilizing the configuration above, the inspection apparatus 100 is capable of increasing a proportion of the inspection light L1 emitted by the inspection light source 130 being reflected to the light-emitting diode 10 by the reflecting cover 110, such that the light-emitting diode 10 may receive more of the inspection light L1 and be excited. Thus, the excited optical data emitted by the light-emitting diode 10 has more diversity. Furthermore, the design also allows more of the excited light L2 emitted by the light-emitting diode 10 to be collected by the light-collecting unit 140. In this way, defective and non-defective products may be distinguished more effectively, such that the inspection apparatus 100 may provide a preferable inspection outcome. It should be noted that when H/W ranges between 3 and 10, an illumination distribution in the enclosed space S becomes more even. Namely, the light emitted into the light-emitting diode 10 after being reflected by the reflecting cover 110 may be more even.

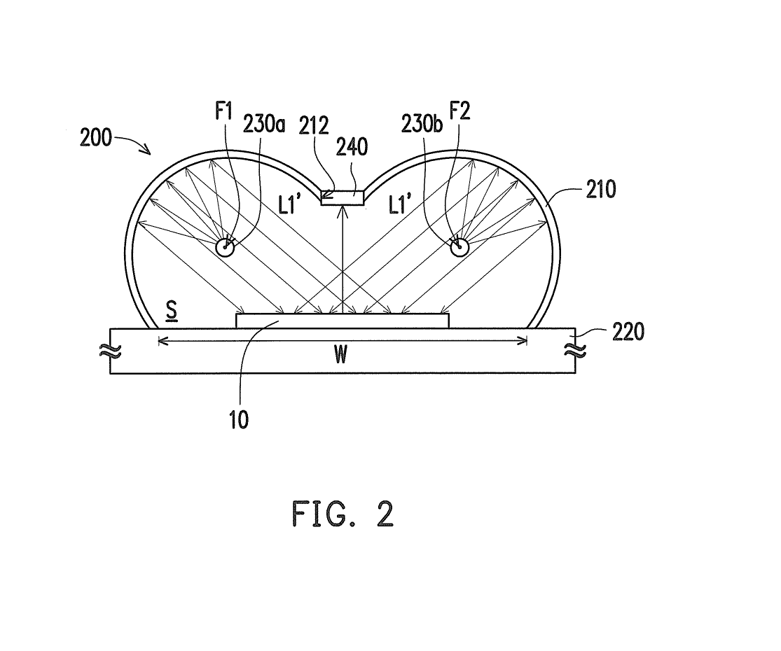

FIG. 2 is a schematic view of an inspection apparatus according to another embodiment of the invention. The reference numerals and a part of the contents in the previous embodiment are used in the following embodiments, in which identical reference numerals indicate identical or similar components, and repeated description of the same technical contents is omitted. For a detailed description of the omitted parts, reference can be found in the previous embodiment, and no repeated description is contained in the following embodiments.

Referring to FIG. 2, an inspection apparatus 200 of FIG. 2 mainly differs from the inspection apparatus 100 of FIG. 1A in that in this embodiment, a reflecting cover 210 has a symmetrical paraboloid structure and has focal points F1 and F2. Inspection light sources 230a and 230b are respectively located on the focal points F1 and F2 of the reflecting cover 210.

Positions of the inspection light sources 230a and 230b are higher than the light-emitting diode 10, instead of being located on the same surface of the light-emitting diode 10. As shown in FIG. 2, in the inspection apparatus 200 of this embodiment, an inspection light L1′ emitted by the inspection light sources 230a and 230b located at the focal points F1 and F2 is reflected by the reflecting cover 210, and then emitted in parallel onto the light-emitting diode 10 evenly. Therefore, when the light-emitting diode 10 of this embodiment is a wafer, the light-emitting diode at the periphery does not emit the excited light L2 that is weaker due to uneven illumination, which may influence the outcome of determination. Therefore, the overall accuracy of inspection may be facilitated.

Besides, in this embodiment, the reflecting cover 210 has a gap 212, and a light-collecting unit 240 is embedded into the gap 212. Namely, a portion of the light-collecting unit 240 of this embodiment is located in the enclosed space S and above the light-emitting diode 10, so as to collect the excited light emitted by the light-emitting diode 10, thereby obtaining the optical data of the light-emitting diode 10. Another portion of the light-collecting unit 240 is located outside the enclosed space S. Therefore, the space taken up by the light-collecting unit 240 in the enclosed space S is reduced, and the chance that the inspection light L1′ is reflected to the light-emitting diode 10 by the reflecting cover 210 is increased.

Based on the above, the light-emitting diode and the inspection light sources of the inspection apparatus of the invention are located in the enclosed space formed by the base plate and the reflecting cover. The inspection light may be reflected to the light-emitting diode by the reflecting cover. With the configuration, the inspection apparatus may allow most of the inspection light emitted by the inspection light sources to be emitted into the light-emitting diode, so as to increase a utilization rate of the detection light sources. Furthermore, with the configuration that the ratio between the distance from the light-collecting unit to the light emitting diode and the width of the opening of the reflecting cover ranges between 0.05 and 10, more of the inspection light may be reflected to the light-emitting diode, and the light-collecting unit may collect more of the optical data emitted from the light-emitting diode. In addition, the reflecting covers in different shapes may have different light-collecting effects. When the symmetrical paraboloid structure is chosen as the reflecting cover and the inspection light sources are disposed at the focal points of the reflecting cover, the originally dispersed inspection light may be converted into the inspection light emitted in parallel to the light-emitting diode by the reflecting cover. Accordingly the light-emitting diode at any point in the enclosed space may evenly receive the emitted light. Variance in the inspecting environment is thus reduced and the accuracy of the inspection apparatus is thus facilitated.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An inspection apparatus, capable of inspecting a light-emitting diode, the inspection apparatus comprising:
a reflecting cover, having an opening;
a base plate, contacting the opening of the reflecting cover and defining an enclosed space with the reflecting cover, wherein the light-emitting diode is disposed on the base plate and located in the enclosed space;
a light-collecting unit, disposed above the light-emitting diode and at least partially located in the enclosed space, wherein a vertical distance from the light-collecting unit to the light-emitting diode is H, a width of the opening of the reflecting cover is W, and H/W=0.05 to 10; and
at least one inspection light source, located in the enclosed space, wherein an inspection light emitted from the inspection light source is reflected by the reflecting cover and then emitted into the LED, and a dominant wavelength of the inspection light is smaller than a dominant wavelength of the light-emitting diode.

2. The inspection apparatus as claimed in claim 1, wherein a shape of a vertical profile of the reflecting cover is an arc shape.

3. The inspection apparatus as claimed in claim 1, wherein a shape of a vertical profile of the reflecting cover is an inverted V shape, an inverted U shape, or a polygonal shape.

4. The inspection apparatus as claimed in claim 1, wherein the number of the at least one inspection light source is two, the light-emitting diode has a central line dividing the light-emitting diode into two blocks, and the inspection light sources are located at two sides of the central line.

5. The inspection apparatus as claimed in claim 1, wherein the at least one inspection light source is disposed on the base plate and adhered to the base plate.

6. The inspection apparatus as claimed in claim 4, wherein the reflecting cover has a symmetrical paraboloid structure and has two focal points, and the inspection light sources are respectively located on the focal points of the reflecting cover.

7. The inspection apparatus as claimed in claim 1, wherein an irradiation area of the inspection light on the base plate after being reflected by the reflecting cover is larger than an area of an orthogonal projection of the light-emitting diode on the base plate, and the orthogonal projection of the light-emitting diode on the base plate is located in an irradiation region of the inspection light on the base plate after being reflected by the reflecting cover.

8. The inspection apparatus as claimed in claim 1, wherein the reflecting cover has a gap, and the light-collecting unit is embedded into the gap.

9. The inspection apparatus as claimed in claim 1, wherein the light-collecting unit comprises a charge coupled device, an integral sphere, a solar panel, or a photodetector array.

10. The inspection apparatus as claimed in claim 1, wherein a reflection rate of the reflecting cover is over 85%.

11. The inspection apparatus as claimed in claim 1, wherein a difference between the dominant wavelength of the inspection light source and the dominant wavelength of the light-emitting diode is at least greater than or equal to 20 nanometers.

12. The inspection apparatus as claimed in claim 1, wherein the dominant wavelength of the inspection light source ranges between 320 nanometers and 400 nanometers.
